(19) United States
(12) Patent Application Publication
(10) Pub. No.: US 2020/0070718 A1
(43) Pub. Date: Mar. 5, 2020

(54) NOTIFICATION DEVICE, NOTIFICATION SYSTEM, AND COMPUTER PROGRAM

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi (JP)

(72) Inventor: Kentaro Tani, Yokkaichi, Mie (JP)

(21) Appl. No.: 16/467,172

(22) PCT Filed: Nov. 27, 2017
(86) PCT No.: PCT/JP2017/042438

§ 371 Date: Jun. 6, 2019

(30) Foreign Application Priority Data
Dec. 7, 2016 (JP) 2016-237844

(51) Int. Cl. B60Q 1/52; B60Q 5/00; B60W 30/095; B60R 1/074

(52) U.S. Cl. CPC B60Q 1/525; B60Q 5/006; B60W 2550/30; B60R 1/074; B60W 30/0956

(57) ABSTRACT

Provided is a notification device configured to be installed in a vehicle and to issue notification of a danger of collision or contact, the notification device including a speed judgment part configured to judge whether a speed of the vehicle is less than or equal to a speed corresponding to slow driving, a danger judgment part configured to, if it is judged that the speed of the vehicle is less than or equal to the speed corresponding to slow driving, judge whether there is a danger of colliding or coming in contact with another vehicle travelling in an opposite direction thereto, and a notification part configured to, if it is judged by the danger judgment part that the danger is present, issue notification of the danger to the other vehicle by a flashing hazard light or a horn device of the vehicle.

### CROSS-REFERENCE TO RELATED APPLICATIONS

This application is the U.S. national stage of PCT/JP2017/042438 filed on Nov. 27, 2017, which claims priority of Japanese Patent Application No. JP 2016-237844 filed on Dec. 7, 2016, the contents of which are incorporated herein.

### TECHNICAL FIELD

The present disclosure relates to a notification device, a notification system and a computer program in a vehicle.

### BACKGROUND

Automobiles in which an advanced driver assistance system (ADAS) is installed are widely available. Advanced driver assistance systems make heavy use of sensing technologies for judging the situation inside and outside of the vehicle, in order to realize functions such as adaptive cruise control, lane keeping assistance and dead angle recognition assistance for assisting safe driving. In a collision damage reduction braking system which is a typical example of an advanced driver assistance system, for example, sensors such as a milliwave radar, an infrared camera or a visible light camera for perceiving obstacles in the direction of travel of the vehicle are used. JP H10-044893A discloses issuing a warning to the surrounding area from a control unit, in the case where a unit that has detected an obstacle in front of the traveling vehicle and judged that there is a high possibility of collision further detects that a danger avoidance maneuver by the driver has been carried out. The driver of a following vehicle is thereby able to more quickly recognize that a so-called sudden steering maneuver has been carried out, and the occurrence of a secondary accident can be avoided.

Conventional advanced driver assistance systems including that disclosed in JP H10-044893A are premised on the vehicle in which the assistance system is installed avoiding dangerous situations. However, there is a high possibility of not being able to completely avoid dangerous situations while the vehicle is traveling unless avoidance maneuvers are also carried out in other vehicles such as oncoming vehicles and following vehicles.

An object of the present disclosure is to provide a notification device, a notification system and a computer program that are capable of making other vehicles as well as the vehicle to which the present invention is applied aware of the possibility of a dangerous situation arising.

### SUMMARY

A notification device according to one aspect of the present disclosure is configured to be installed in a vehicle and to issue notification of a danger of collision or contact, the notification device including a speed judgment part configured to judge whether a speed of the vehicle is less than or equal to a speed corresponding to slow driving, a danger judgment part configured to, if it is judged that the speed of the vehicle is less than or equal to the speed corresponding to slow driving, judge whether there is a danger of colliding or coming in contact with another vehicle travelling in an opposite direction thereto, and a notification part configured to, if it is judged by the danger judgment part that the danger is present, issue notification of the danger to the other vehicle by a flashing hazard light or a horn device of the vehicle.

A notification system according to one aspect of the present disclosure is configured to be installed in a vehicle and includes a notification device provided externally to the vehicle and configured to issue light or sound externally, and a collision avoidance device that has an oncoming vehicle detection part configured to detect another vehicle facing the vehicle from in front and a distance measurement part configured to measure a distance to the detected other vehicle, and that is configured to judge whether there is a danger of colliding or coming in contact with the other vehicle, the notification device including a speed judgment part configured to judge whether a speed of the vehicle is less than or equal to a speed corresponding to slow driving, a measurement result acquisition part configured to acquire a result of the distance to the other vehicle detected by the oncoming vehicle detection part being measured by the distance measurement part, a first notification part configured to turn on a flashing hazard light, if it is judged by the collision avoidance device that the danger is present and the distance acquired by the measurement result acquisition part is less than or equal to a predetermined first distance and longer than a second distance that is shorter than the first distance, and a second notification part configured to issue a warning using a horn device together with turning on the flashing hazard light, if the acquired distance is less than or equal to the second distance.

A computer program according to one aspect of the present disclosure is configured to cause a computer to judge whether a speed of a vehicle is less than or equal to a speed corresponding to slow driving, judge, if it is judged that the speed of the vehicle is less than or equal to the speed corresponding to slow driving, whether there is a danger of colliding or coming in contact with another vehicle travelling in an opposite direction thereto, and issue, if it is judged that the danger is present, notification of the danger to the other vehicle by a flashing hazard light or a horn device of the vehicle.

Note that the instant invention can not only be realized as a notification device that includes devices provided with such characteristic constituent parts, but can also be realized as a notification method that includes related characteristic steps. Also, the instant invention can be realized as a semiconductor integrated circuit that realizes some or all of the constituent parts of the notification device, or can be realized as a notification system or other system that uses the notification device.

### Advantageous Effects of Invention

According to the above, it is possible to make other vehicles as well as the vehicle to which the present invention is applied aware of the possibility of a dangerous situation arising.

### BRIEF DESCRIPTION OF DRAWINGS

FIG. 1 is a block diagram showing the configuration of a notification system in a first embodiment.

FIG. 2 is a flowchart showing an example of a processing procedure performed by a BCM unit of the first embodiment.

FIG. 3 is an illustrative diagram schematically showing operations of the BCM unit in the first embodiment.

FIG. 4 is an illustrative diagram schematically showing operations of the BCM unit in the first embodiment.

FIG. 5 is an illustrative diagram schematically showing operations of the BCM unit in the first embodiment.

FIG. 6 is an illustrative diagram schematically showing operations of the

BCM unit in the first embodiment.

### DETAILED DESCRIPTION OF PREFERRED EMBODIMENTS

Initially, embodiments of the present disclosure will be listed and described. Also, at least some of the embodiments described below may be suitably combined.

A notification device according to one aspect of the present disclosure is configured to be installed in a vehicle and to issue notification of a danger of collision or contact, the notification device including a speed judgment part configured to judge whether a speed of the vehicle is less than or equal to a speed corresponding to slow driving, a danger judgment part configured to, if it is judged that the speed of the vehicle is less than or equal to the speed corresponding to slow driving, judge whether there is a danger of colliding or coming in contact with another vehicle travelling in an opposite direction thereto, and a notification part configured to, if it is judged by the danger judgment part that the danger is present, issue notification of the danger to the other vehicle by a flashing hazard light or a horn device of the vehicle.

In the above aspect of the present disclosure, in the case where it is judged that there is a danger of colliding or coming in contact with another vehicle travelling in the opposite direction thereto, that is, in the case where there is a danger of coming in contact with an oncoming vehicle when the vehicles pass each other, the oncoming vehicle is notified of the danger. The possibility of being able to avoid colliding or coming in contact with an oncoming vehicle when the vehicles pass each other on a narrow road thereby increases.

The notification device according to one aspect of the present disclosure further includes a distance acquisition part configured to acquire a result of measuring a distance between the vehicle and the other vehicle, and the notification part includes a first notification part configured to turn on the flashing hazard light of the vehicle, if the distance acquired by the distance acquisition part is less than or equal to a predetermined first distance and longer than a second distance that is shorter than the first distance, and a second notification part configured to issue a warning using the horn device of the vehicle in addition to turning on the flashing hazard light, if the acquired distance is less than or equal to the second distance.

In the above aspect of the present disclosure, the method of notification changes from flashing of hazard lights to additional notification using the horn depending on the distance, thus making it possible to more reliably issue notification of dangerous situations, and to avoid colliding or coming in contact with an oncoming vehicle when the vehicles pass each other.

The notification device according to one aspect of the present disclosure outputs a signal for causing a movable exterior mirror projecting in a width direction of the vehicle to be retracted.

In the above aspect of the present disclosure, exterior mirrors projecting outward in the width direction of the vehicle are retracted, thus further ensuring that colliding or coming in contact with an oncoming vehicle when the vehicles pass each other is avoided.

A notification system according to one aspect of the present disclosure is configured to be installed in a vehicle and includes a notification device provided externally to the vehicle and configured to issue light or sound externally, and a collision avoidance device that has an oncoming vehicle detection part configured to detect another vehicle facing the vehicle from in front and a distance measurement part configured to measure a distance to the detected other vehicle, and that is configured to judge whether there is a danger of colliding or coming in contact with the other vehicle, the notification device including a speed judgment part configured to judge whether a speed of the vehicle is less than or equal to a speed corresponding to slow driving, a measurement result acquisition part configured to acquire a result of the distance to the other vehicle detected by the oncoming vehicle detection part being measured by the distance measurement part, a first notification part configured to turn on a flashing hazard light, if it is judged by the collision avoidance device that the danger is present and the distance acquired by the measurement result acquisition part is less than or equal to a predetermined first distance and longer than a second distance that is shorter than the first distance, and a second notification part configured to issue a warning using a horn device together with turning on the flashing hazard light, if the acquired distance is less than or equal to the second distance.

In the above aspect of the present disclosure, similarly to the abovementioned aspect (1), in the case where the collision avoidance device judges that there is a danger of colliding or coming in contact with another vehicle travelling in the opposite direction thereto, the oncoming vehicle is notified of the danger by the notification device that controls the flashing hazard lights or the horn. The possibility of being able to avoid colliding or coming in contact with an oncoming vehicle when the vehicles pass each other on a narrow road thereby increases.

A computer program according to one aspect of the present disclosure is configured to cause a computer to judge whether a speed of a vehicle is less than or equal to a speed corresponding to slow driving, judge, if it is judged that the speed of the vehicle is less than or equal to the speed corresponding to slow driving, whether there is a danger of colliding or coming in contact with another vehicle travelling in an opposite direction thereto, and issue, if it is judged that the danger is present, notification of the danger to the other vehicle by a flashing hazard light or a horn device of the vehicle.

In the above aspect of the present disclosure, similarly to the abovementioned aspect (1), in the case where it is judged that there is danger of colliding or coming in contact with another vehicle travelling in the opposite direction thereto, the oncoming vehicle is notified of the danger by the notification device that controls the flashing hazard lights or the horn. The possibility of being able to avoid colliding or coming in contact with an oncoming vehicle when the vehicles pass each other on a narrow road thereby increases.

Specific examples of a notification device according to embodiments of the present disclosure will be described hereinafter, with reference to the drawings. Note that the present invention is not limited to these illustrative examples, and all changes that come within the meaning and range of equivalency of the claims are intended to be encompassed therein.

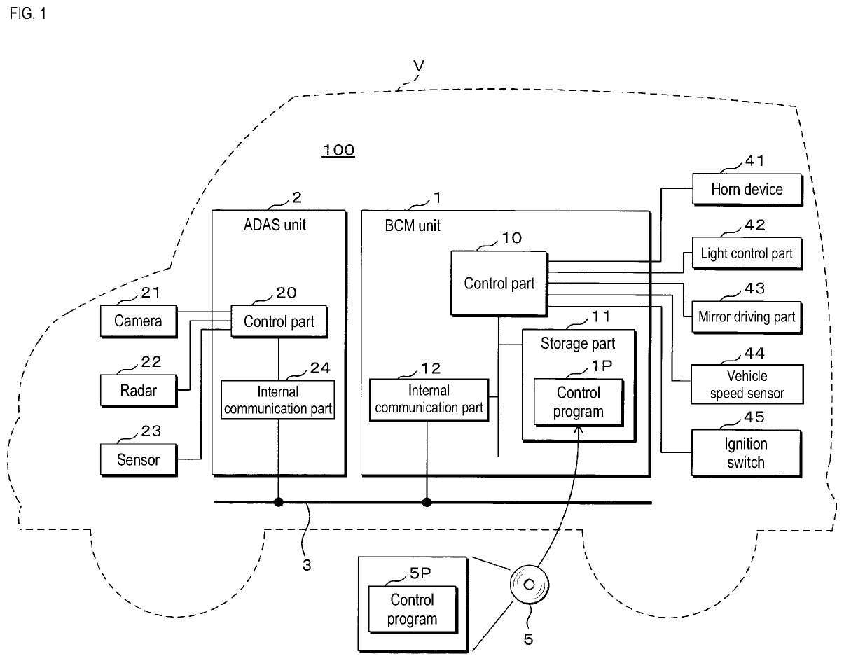

FIG. 1 is a block diagram showing the configuration of a notification system 100 in the present embodiment. The notification system 100 in the present embodiment includes a BCM (Body Control Module) unit 1 and an ADAS unit 2 that are installed in a vehicle V The BCM unit 1 and the ADAS unit 2 are connected via an internal communication bus 3. The internal communication bus 3 is a communication medium corresponding to a predetermined communication protocol, and is a CAN (Control Area Network) bus or an Ethernet (registered trademark) cable, for example.

The BCM unit 1 is a unit that performs control of locking/unlocking of a door lock of the vehicle V and control of body-related actuators such as interior and exterior lights in an integrated manner. The BCM unit 1 according to the present embodiment, specifically, is connected to a horn device (horn) 41 of the vehicle V, a light control part 42 of lights such as headlights and direction indicator lights, and a mirror driving part 43 of exterior mirrors. The BCM unit 1 is provided with a control part 10, a storage part 11, and an internal communication part 12.

The control part 10 is a micro controller that uses one or a plurality of CPUs (Central Processing Units) or a multi-core CPU, and has a ROM (Read Only Memory), a RAM (Random Access Memory), an input-output interface, a timer, and the like. The control part 10 controls the constituent parts, based on a control program 1P stored in the storage part 11, and outputs instruction signals to the horn device 41, the light control part 42, and the mirror driving part 43. Also, the control part 10 is connected to sensors such as a vehicle speed sensor 44, and takes signals output from these sensors as input signals. Also, it is possible to input a signal indicating the state of an ignition switch 45, and recognize states such as ignition ON, OFF and ACC.

The storage part 11 uses a nonvolatile memory such as a flash memory. The storage part 11 stores the abovementioned control program 1P, in addition to storing various types of information that are referred to by the control part 10. A mode in which the control program 1P that is stored in the storage part 11 is recorded on a computer-readable recording medium 5 may also be adopted. The storage part 11 stores a control program 5P read out from the recording medium 5 by a readout device which is not illustrated. The recording medium 5 is an optical disk such as a CD-ROM (Compact Disc ROM), a DVD-ROM (Digital Versatile Disc ROM) or a BD (Blu-ray (registered trademark) Disc), a magnetic disk such as a flexible disk or a hard disk, a magnetic optical disk, a semiconductor memory, or the like. Also, the control program 5P according to the first embodiment may be downloaded from an external computer (not shown) that is connected to a communication network (not shown), and stored in the storage part 11. Note that the control program 1P may be stored in a built-in ROM of the control part 10.

The internal communication part 12 uses a CAN transceiver or an Ethernet (registered trademark) network card. The control part 10 has a function of a communication controller, and performs transmission and reception of information with other devices via the internal communication bus 3, based on a predetermined communication protocol, using the internal communication part 12.

The ADAS unit 2 is a device that is connected to a plurality of a camera 21, a radar 22 and a sensor 23, and detects the danger of collision or contact around the vehicle V based on sensing signals that are input therefrom. The ADAS unit 2 is provided with a control part 20 and an internal communication part 24 that realizes communication via the internal communication bus 3. The control part 20 constantly judges whether there is a danger of collision or contact based on the camera 21, the radar 22 and the sensor 23, using the internal communication part 24 or directly, when starting (ignition ON) of the engine or a drive battery system is detected. When the danger of collision or contact is detected, the control part 20 issues notification of this danger to the internal communication bus 3, using the internal communication part 24.

The camera 21 includes at least a camera provided facing forward of the vehicle V. In addition, the camera 21 may include cameras provided facing backward and laterally. The radar 22 is a milliwave radar provided facing forward on the outer side of the vehicle V, and is used in measurement of distance from objects in front. The sensor 23 measures the distance from objects (persons, other vehicles, etc.) that are in front, to the side and behind, using an ultrasonic sensor, an infrared sensor or the like.

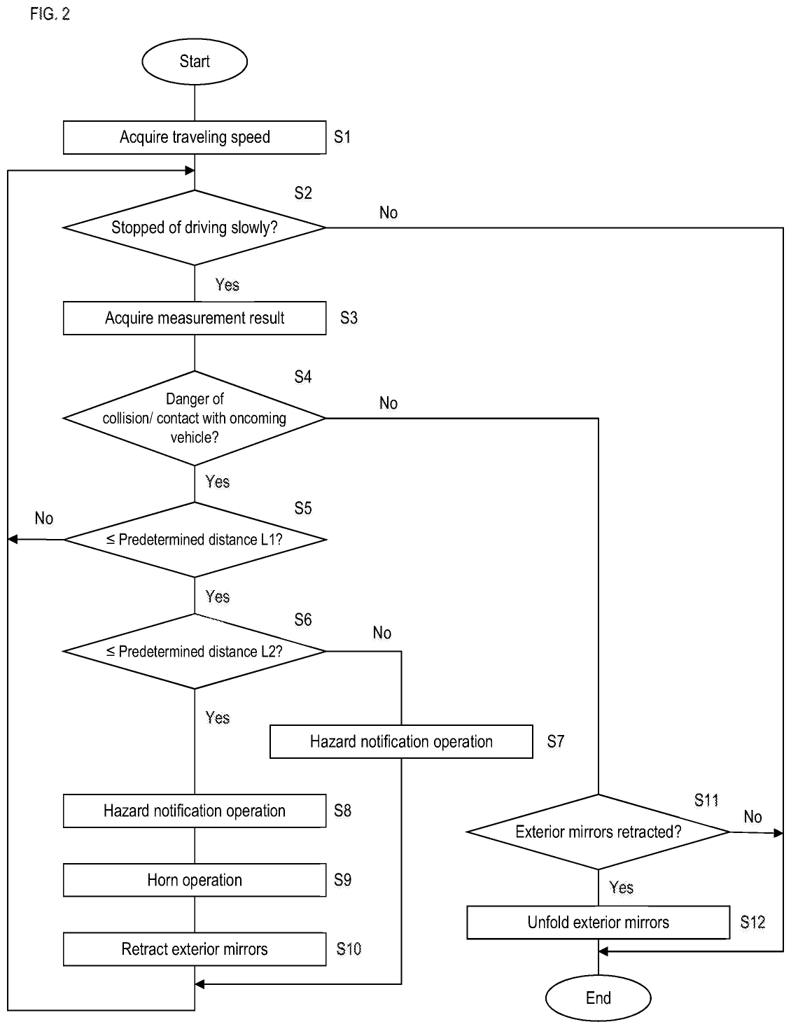

With the notification system 100 of the present embodiment, in a situation where vehicles pass each other on a narrow road, the BCM unit 1 notifies the oncoming vehicle using portions controllable thereby, in the case where the danger of collision or contact is detected by the ADAS unit 2. Furthermore, the BCM unit 1, if needed, drives the controllable portions to avoid collision or contact when the vehicles pass each other. FIG. 2 is a flowchart showing an example of a processing procedure performed by the BCM unit 1 of the present embodiment. Note that the control part 10, in the case where the ignition switch 45 is in an ON state, repeatedly executes the processing procedure shown below constantly (e.g., whenever a predetermined time elapses).

The control part 10 acquires the traveling speed of the vehicle V in which the BCM unit 1 is installed from the vehicle speed sensor 44 (step S1). The control part 10 judges whether the vehicle V is in a stopped or slow driving state depending on whether the traveling speed is less than or equal to a predetermined speed (e.g., 10 km/hr) (step S2).

If it is judged that the vehicle V is in a stopped or slow driving state (S2: YES), the control part 10 acquires a measurement result regarding the danger of colliding or coming in contact with an oncoming vehicle from the ADAS unit 2 (step S3). The ADAS unit 2 is constantly detecting oncoming vehicles using information that is acquired from the camera 21, the radar 22 and the sensor 23, and measuring the distance to the oncoming vehicles. The control part 10 of the BCM unit 1 acquires the presence of an oncoming vehicle and a result of the distance measurement as the measurement result in step S3.

The control part 10 judges whether there is a danger of colliding or coming in contact with the oncoming vehicle from the acquired measurement result (step S4), and, if it is judged that the danger is present (S4: YES), judges whether the distance to the oncoming vehicle included in the measurement result is less than or equal to a predetermined distance L1 (step S5). Note that a configuration may be adopted in which the judgment of whether there is a danger of collision or contact in step S4 is performed in the ADAS unit 2, and the control part 10 of the BCM unit 1 acquires the judgment result from the ADAS unit. Also, a configuration may be adopted in which the control part 10, in step S4, judges whether the width of the road along which the vehicle V is traveling is narrower than a predetermined width based on information from a navigation device of the vehicle V of the like, and, the processing of step S5 onward is performed if the road is difficult for vehicles to pass each other on.

If it is judged in step S5 that the distance to the oncoming vehicle is less than or equal to the predetermined distance L1 (S5: YES), the control part 10 judges whether the distance to the oncoming vehicle is less than or equal to a predetermined distance L2 that is shorter than the predetermined distance L1 (step S6).

If it is judged in step S6 that the distance to the oncoming vehicle is longer than the predetermined distance L2 (S6: NO), the control part 10 causes the light control part 42 to execute a hazard notification operation for flashing all of the direction indicator lights (step S7), and returns the processing to step S3.

If it is judged in step S6 that the distance to the oncoming vehicle has closed to less than or equal to the predetermined distance L2 (S6: YES), the control part 10 executes a hazard notification operation for issuing a stronger warning to the oncoming vehicle (step S8). Furthermore, the control part 10 causes the horn device 41 to generate a sound that attracts attention (step S9), instructs the mirror driving part 43 to retract the exterior mirrors (step S10), and returns the processing to step S3 and acquires the distance measurement result (S3). Note that the flashing cycle of the hazard lights in step S8 can be made shorter than in the hazard notification operation of step S7. Also, in step S10, the portion to be retracted by the control part 10 is not limited to the exterior mirrors. In the case where there is a portion, other than the exterior mirrors, that is in danger of colliding or coming in contact with the oncoming vehicle when the vehicles pass each other and that portion is controllable by the BCM unit 1, that portion may also be retracted or the like.

If it is judged in step S5 that the distance to the oncoming vehicle is longer than the predetermined distance L1 (S5: NO), the control part 10 returns the processing to step S3, and acquires the measurement result again (S3).

If it is judged in step S4 that there is no danger of colliding or coming in contact with the oncoming vehicle or that the danger of collision or contact is no longer present according to the most recent measurement (S4: NO), the control part 10 judges whether the exterior mirrors are retracted (step S11). If it is judged in step S11 that the exterior mirrors are retracted (S11: YES), the control part 10 instructs the mirror driving part 43 to unfold the exterior mirrors (step S12), and ends the processing. If it is judged in step S11 that the exterior mirrors are not retracted (S11: NO), the control part 10 directly ends the processing.

If it is judged in step S2 that the vehicle V is not in a stopped or slow driving state (S2: NO), the control part 10 directly ends the processing. Processing regarding the danger of collision or contact in the case where the vehicle V is not in a stopped or slow driving state, that is, in the case where the vehicle V is traveling faster than a predetermined speed, can be executed with the ADAS unit 2 separately.

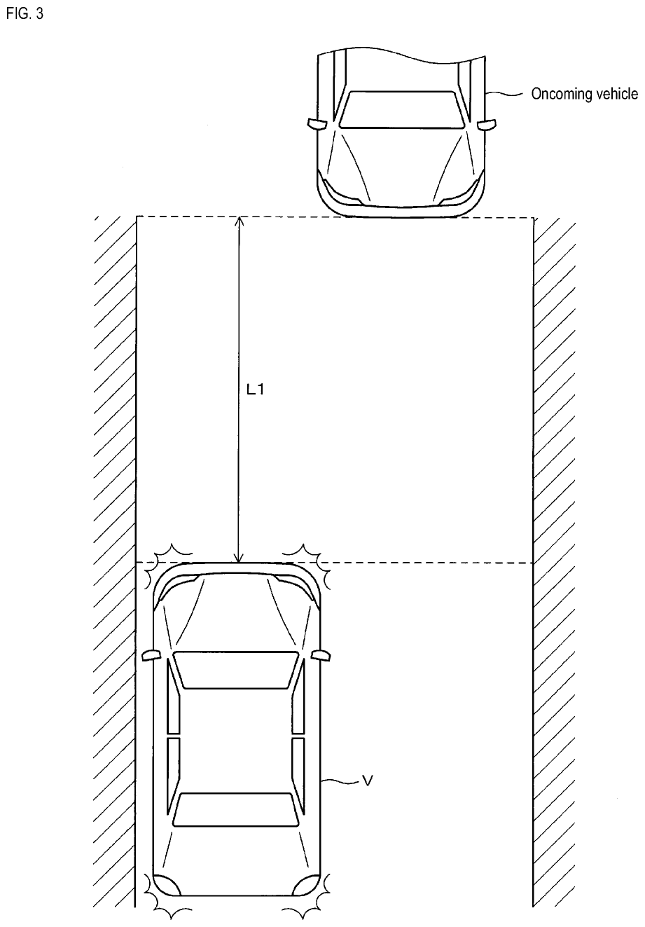

FIGS. 3 to 6 are diagrams schematically showing operations of the BCM unit 1 in the present embodiment. A situation in which the vehicle V and an oncoming vehicle pass each other is shown in chronological order from FIG. 3. FIG. 3 shows the situation where the distance to the oncoming vehicle from the vehicle V which is stopped on a narrow road has closed to less than or equal to the predetermined distance L1. In the state shown in FIG. 3, the control part 10 of the BCM unit 1 of the vehicle V judges that the distance to the oncoming vehicle is less than or equal to the predetermined distance L1 but longer than the predetermined distance L2 (S6: NO), and the hazard notification operation is performed as shown in the diagram (S7).

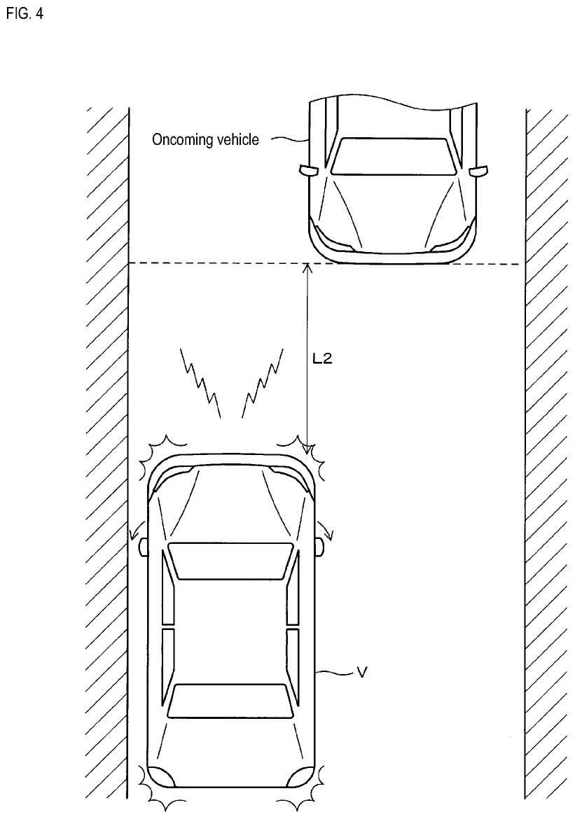

FIG. 4 shows the situation where the oncoming vehicle has closed to less than or equal to the predetermined distance L2. In the state shown in FIG. 4, the control part 10 of the BCM unit 1 of the vehicle V judges that the distance to the oncoming vehicle is less than or equal to the predetermined distance L2 (S6: YES), and sounding of the horn and retracting of the exterior mirrors are performed in addition to the hazard notification operation as shown in the diagram (S8 to S10).

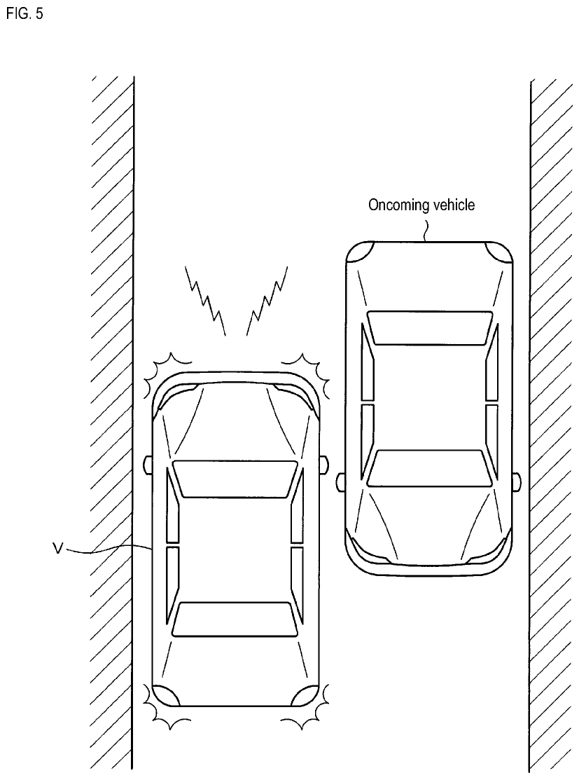

FIG. 5 shows the situation where the distance between the vehicle V and the oncoming vehicle is less than or equal to the predetermined distance L2 and the vehicles are furthermore passing each other. In the state shown in FIG. 5, the control part 10 of the BCM unit 1 of the vehicle V judges that the distance to the oncoming vehicle is still less than or equal to the predetermined distance L2 (S6: YES), and thus continues to sound the horn and retract the exterior mirrors in addition to the hazard notification operation as shown in the diagram (S8 to S10).

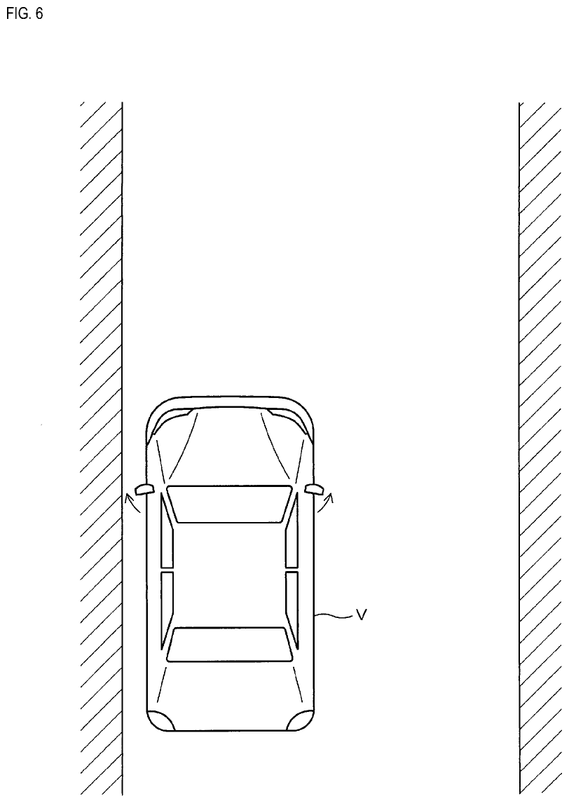

FIG. 6 shows the situation after the vehicle V and the oncoming vehicle have passed each other and it has been judged by the ADAS unit 2 that there is no danger of collision or contact. In the state shown in FIG. 6, the control part 10 of the BCM unit 1 of the vehicle V judges that there is no danger of colliding or coming in contact with an oncoming vehicle. Because it is judged that the exterior mirrors are retracted (S11: YES), the exterior mirrors are unfolded again as shown in FIG. 6 (S12).

In this way, in the case where there is a danger of collision or contact when the vehicle V and an oncoming vehicle pass each other in a state where the vehicle V is stopped or driving slowly, not only is a warning issued in the vehicle V to the driver of the vehicle V to avoid the danger but the oncoming vehicle is also notified of the danger. The driver of the oncoming vehicle is prompted to carry out a maneuver to avoid collision or contact, and the possibility of collision or contact being avoided thereby increases. Also, given that the exterior mirrors projecting outward in the width direction of the vehicle are in the greatest danger of colliding or coming in contact with the oncoming vehicle, these exterior mirrors are automatically retracted, and collision or contact is thus better avoided.

In the abovementioned embodiment, the control part 10 of the BCM unit 1 is configured to perform processing between the BCM unit 1 and the ADAS unit 2 that are installed in the vehicle V. However, there is a possibility of being able to perform transmission and reception of information between a BCM installed in the oncoming vehicle and the BCM unit 1 of the vehicle V, via the internal communication bus 3 and a vehicle-to-vehicle communication device. In this case, a configuration may be adopted in which the control part 10 issues notification of the danger of collision or contact to the BCM of the oncoming vehicle via vehicle-to-vehicle communication, and an avoidance maneuver is performed through mutual cooperation, by the BCM of the oncoming vehicle issuing a warning through an in-vehicle speaker, for instance.

In the abovementioned embodiment, the control part 10 of the BCM unit 1 executes the processing procedure shown in the flowchart of FIG. 2 in the case where the ignition switch is in an ON state. However, a configuration may be adopted in which the notification system 100 according to the present disclosure executes the processing procedure shown in the flowchart of FIG. 2 when a predetermined security function is in an ON state, for example, even when the vehicle V is stopped with the ignition switch in an OFF state.

The disclosed embodiment is considered in all respects to be illustrative and not restrictive. The scope of the invention is indicated by the claims rather than by the abovementioned content, and all changes that come within the meaning and range of equivalency of the claims are intended to be encompassed therein.

1. A notification device configured to be installed in a vehicle and to issue notification of a danger of collision or contact, comprising:
a speed judgment part configured to judge whether the vehicle is in a stopped state based on a speed of the vehicle;
a danger judgment part configured to, if it is judged by the speed judgment part that the vehicle is in the stopped state, judge whether there is a danger of colliding or coming in contact with another vehicle travelling in an opposite direction thereto; and
a notification part configured to, if it is judged by the danger judgment part that the danger is present, issue notification of the danger to the other vehicle by a flashing hazard light or a horn device of the vehicle.

2. The notification device according to claim 1, further comprising:
a distance acquisition part configured to acquire a result of measuring a distance between the vehicle and the other vehicle,
wherein the notification part includes:
a first notification part configured to turn on the flashing hazard light of the vehicle, if the distance acquired by the distance acquisition part is less than or equal to a predetermined first distance and longer than a second distance that is shorter than the first distance; and
a second notification part configured to issue a warning using the horn device of the vehicle in addition to turning on the flashing hazard light, if the acquired distance is less than or equal to the second distance.

3. The notification device according to claim 2,
wherein the notification device outputs a signal for causing a movable exterior mirror projecting in a width direction of the vehicle to be retracted.

4. A notification system configured to be installed in a vehicle and comprising a notification device provided externally to the vehicle and configured to issue light or sound externally, and a collision avoidance device that has an oncoming vehicle detection part configured to detect another vehicle facing the vehicle from in front and a distance measurement part configured to measure a distance to the detected other vehicle, and that is configured to judge whether there is a danger of colliding or coming in contact with the other vehicle,
the notification device including:
a speed judgment part configured to judge whether the vehicle is in a stopped state based on a speed of the vehicle;
a measurement result acquisition part configured to, if it is judged by the speed judgment part that the vehicle is in the stopped state, acquire a result of the distance to the other vehicle detected by the oncoming vehicle detection part being measured by the distance measurement part;
a first notification part configured to, if it is judged by the speed judgment part that the vehicle is in the stopped state, turn on a flashing hazard light, if it is judged by the collision avoidance device that the danger is present and the distance acquired by the measurement result acquisition part is less than or equal to a predetermined first distance and longer than a second distance that is shorter than the first distance; and
a second notification part configured to, if it is judged by the speed judgment part that the vehicle is in the stopped state, issue a warning using a horn device together with turning on the flashing hazard light, if the acquired distance is less than or equal to the second distance.

5. A computer program configured to cause a computer to:
judge whether a vehicle in which the computer is installed is in a stopped state based on a speed of the vehicle;
judge, if it is judged that the vehicle is in the stopped state, whether there is a danger of colliding or coming in contact with another vehicle travelling in an opposite direction thereto; and
issue, if it is judged that the danger is present, notification of the danger to the other vehicle by a flashing hazard light or a horn device of the vehicle.
